(19) United States
(12) Patent Application Publication
(10) Pub. No.: US 2009/0324226 A1
(43) Pub. Date: Dec. 31, 2009

(54) System, method and apparatus for channel estimation based on intra-symbol frequency domain averaging for coherent optical OFDM

(76) Inventors: Fred Buchali, Waiblingen (DE); Xiang Liu, Marlboro, NJ (US)

Correspondence Address: Docket Administrator (Room 2F-192);Lucent Technologies, Inc., 600 Mountain Avenue, Murray Hill, NJ, 07974-0636, US

(21) Appl. No.: 12/215,740

(22) Filed: Jun. 30, 2008

(51) Int. Cl. H04J 14/00

(52) U.S. Cl. 398/76

(57) ABSTRACT

System, apparatus and method of optical communication are provided for performing efficient channel estimation for a CO-OFDM link utilizing an intra-symbol frequency-domain averaging (ISFA) to compensate for transmission impairments. An exemplary method includes receiving a pair of training symbols in an optical orthogonal frequency-division multiplexed (OFDM) signal, performing channel estimation to obtain a first estimated channel matrix for each of a plurality of subcarriers of the OFDM signal; and averaging the first estimated channel matrix of a first subcarrier with the first estimated channel matrix of others of the subcarriers to obtain a second estimated channel matrix for the first subcarrier. The second estimated channel matrix may be an average or weighted average. Prior to the averaging, compensation of chromatic dispersion may be performed. Channel compensation is performed based on the second estimated channel matrix for the first subcarrier of the OFDM signal and symbols then decoded.

### FIELD OF THE INVENTION

The invention relates to optical transmission systems, and, in particular, to systems, apparatuses and techniques for coherent optical orthogonal frequency-division multiplexing (CO-OFDM) systems that employ channel estimation.

### BACKGROUND INFORMATION

Chromatic dispersion (CD) is a deterministic distortion given by the design of the optical fiber. It leads to a frequency dependence of the optical phase and its effect on transmitted signal scales quadratically with the bandwidth consumption or equivalently the data rate. Therefore the CD tolerances are reduced to 1/16, if the data rate of a signal is increased by a factor of 4. Up to 2.5 Gb/s data rate optical data transmission is feasible without any compensation of CD even at long haul distances. At 10 Gb/s, the consideration of chromatic dispersion becomes necessary, and dispersion compensating fibers (DCF) are often used. At 40 Gb/s and beyond, even after the application of DCF the residual CD may still be too large.

Polarization-mode dispersion (PMD) is a stochastic characteristic of optical fiber due to imperfections in production and installation. Pre-1990 fibers exhibit high PMD values well above 0.1 ps/√km which are border line even for 10 Gb/s. Newer fibers have a PMD lower than 0.1 ps/√km, but other optical components in a fiber link such as reconfigurable add/drop multiplexers (ROADMs) may cause substantial PMD. If 40 Gb/s systems are to be operated over the older fiber links or new fiber links with many ROADMs, PMD may become a significant detriment. PMD can be compensated by optical elements with an inverse transmission characteristics to the fiber. However, due to the statistical nature of PMD with fast variation speeds up to the few kHz range, the realization of optical PMD compensators is challenging. With increases in channel data rate, optical signal is more and more limited by the transmission impairments in optical fiber such as CD and PMD.

Orthogonal frequency-division multiplexing (OFDM) is a widely used digital modulation/multiplexing technique. Coherent optical orthogonal frequency-division multiplexing (CO-OFDM) is being considered as a promising technology for future high-speed (e.g., 100-Gb/s) optical transport systems. In long-haul optical transmissions, the accuracy of the channel estimation is usually limited by optical noise and fiber nonlinear effects. The efficiency of the channel estimation is often limited by the use of multiple training symbols for channel estimation.

### SUMMARY OF THE INVENTION

In CO-OFDM, accurate and efficient channel estimation is desirable in order to compensate for transmission impairments such as CD and PMD. System, method and apparatus embodiments of the invention are provided that efficiently perform channel estimation for a CO-OFDM link suffering from noise and nonlinear transmission impairments. An exemplary method of optical communication that includes intra-symbol frequency-domain averaging (ISFA) based channel estimation scheme is proposed.

The exemplary method includes receiving a pair of training symbols in an optical orthogonal frequency-division multiplexed (OFDM) signal, performing channel estimation to obtain a first estimated channel matrix for each of a plurality of subcarriers of the OFDM signal; and averaging the first estimated channel matrix of a first subcarrier with the first estimated channel matrix of at least a second subcarrier to obtain a second estimated channel matrix for the first subcarrier.

The averaged channel matrix may be an average or a weighted average of channel matrices estimated in the first instance for some number different subcarriers. The different subcarrier used for calculating the averaged channel matrix can include a predetermined number of right neighboring subcarriers and/or left neighboring subcarriers. The first and/or second estimated channel matrices may be 2×2 matrix with complex numbers as elements.

The method may further include performing channel compensation based on the second estimated channel matrix for the first subcarrier of the OFDM signal and decoding the data information carried by the first subcarrier of the OFDM signal based on the compensated subcarrier. For example, the second estimated channel matrix can be inverted and the inverted matrix multiplied with the received subcarrier vector for the first subcarrier of the OFDM signal to perform channel compensation of the first subcarrier. A second estimated channel matrix may also be determined for each subcarrier and used for compensation/decoding each subcarrier of the OFDM signal.

The pair of training symbols can be received periodically in the OFDM signal in order to update the estimated channel matrices and may or may not be the same pair of training symbols in each iteration of the method. Training symbols may be time-multiplexed training symbols and/or alternating in polarization. The OFDM signal may be polarization-division multiplexed (PDM) so that information is carried in two orthogonal polarization states of an optical wave. Estimation of the optical channel includes determining a functional relationship between the received pair of training symbols and a transmitted pair of training symbols on a per-subcarrier basis. Optical dispersion compensation or electronic dispersion compensation (EDC) of the received training symbols and/or the received OFDM signal may need to be performed before the ISFA procedure.

Embodiments of an optical communication system for implementing disclosed system include an OFDM receiver that has a receiver front-end for receiving a pair of training symbols in an optical OFDM signal; and a channel estimation module for performing channel estimation to obtain a first estimated channel matrix for each of a plurality of subcarriers of the OFDM signal, and for averaging the first estimated channel matrix of a first subcarrier with the first estimated channel matrix of at least a second subcarrier to obtain a second estimated channel matrix for the first subcarrier. The system may further include an OFDM transmitter having a training symbol insertion module for inserting a pair of training symbols into the OFDM symbol sequence.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein

FIG. 1 is a schematic diagram of an exemplary optical transmission system that employs intra-symbol frequency-domain averaging (ISFA) based channel estimation; and

FIG. 2 is a flow chart illustrating a method in a compensation module of an orthogonal frequency-division multiplexed (OFDM) receiver for processing a signal according to a preferred embodiment of the invention.

### DETAILED DESCRIPTION

Various example embodiments will now be described more fully with reference to the accompanying figures in which like numbers refer to like elements throughout the description of the figures.

Specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, etc. may be used herein to describe various elements, these elements should not be limited by these term since such terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items, and the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

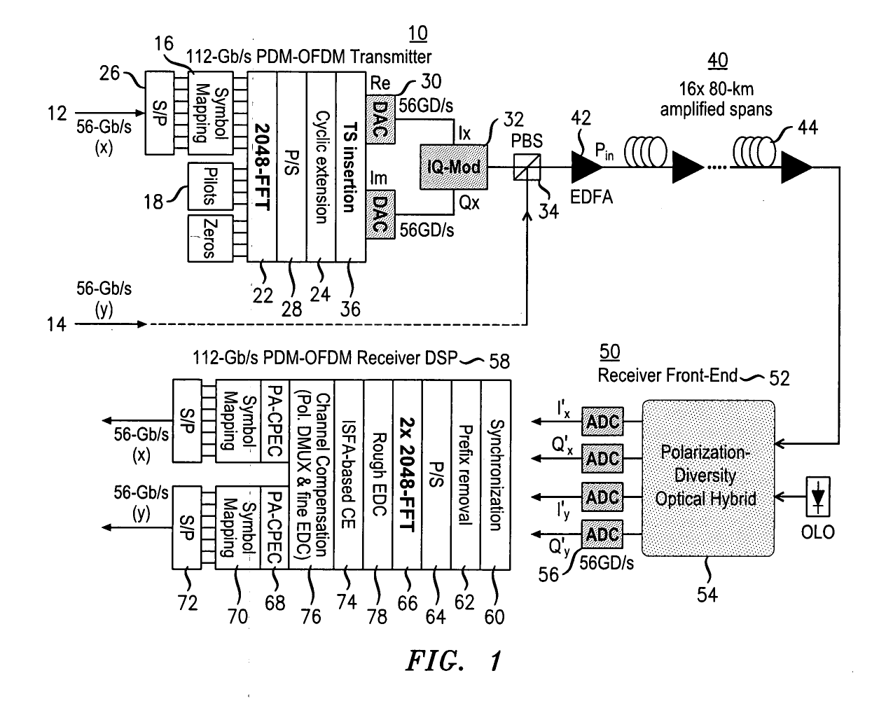

FIG. 1 is schematic diagram of an exemplary optical transmission system that employs intra-symbol frequency-domain averaging (ISFA) based channel estimation. A 112-Gb/s PDM-OFDM transmitter 10 is connected via an optically amplified transmission link 20 to a 112-Gb/s PDM-OFDM receiver setup. Other data rate signals can be handled in a similar manner.

At the transmitter 10, the original 112-Gb/s data (not shown) are first divided into x- and y-polarization branches 12 and 14 each of which is mapped by symbol mapping module 16 onto frequency subcarriers with modulation, which, together with pilot subcarriers provided by pilot module 18, are transferred to the time domain by an Inverse Fast Fourier Transform (IFFT) supplied by IFFT module 20. For example, each polarization branch 12 or 14 may be mapped onto 1280 frequency subcarriers with quadrature phase shift keying (QPSK) modulation, which, together with 16 pilot subcarriers, are transferred to the time domain by an IFFT of size 2048 with a filling ratio of ˜63%. The total number of filled subcarriers is thus 1296. The 16 pilot subcarriers are preferably distributed uniformly in the frequency domain.

A cyclic prefix may be inserted by cyclic extension module 24 to accommodate inter-symbol interference which may be caused by CD and PMD in the optical transmission link 20. For example, a cyclic prefix of length 512 can be used to accommodate dispersion of up to ˜20,000 ps/nm, resulting in an OFDM symbol size of 2560.

The IFFT algorithm is organized on a symbol basis requiring a parallelization via a serial-to-parallel module 26 of input data before application of the algorithm and a serialization via parallel-to-serial module 28 afterwards. After parallelization of data in the transmitter a coder is required transferring a binary on-off coding into, for example, a four level phase modulation signal with the amplitudes [−1, +1, −j, +j].

The superposition of multiple frequency carriers leads to an analog signal in the time domain. Hence a digital-to-analog converter (DAC) 30 is required after serialization in the transmitter and opposite analog-to-digital converter (ADC) in the receiver in front of the pure digital signal processing. The DAC operates at a given sampling rate. For example, after the time-domain samples corresponding to the real and imaginary parts of one polarization component of the PDM-OFDM signal are serialized they may be converted by two 56-GS/s DACs.

The two analog waveforms converted by the two DACs are used to drive an I/Q modulator 32 to form one polarization component of the PDM-OFDM signal, which is then combined with the other polarization component of the PDM-OFDM signal generated similarly (not shown) by a polarization beam splitter (PBS) 34 to form the original PDM-OFDM signal. The transmitter also includes a training symbol insertion module 36 for inserting training symbols (TS's) for use in channel estimation.

The orthogonal frequency-division multiplexed (OFDM) signal is carried via an optically amplified transmission link 40 to a 112-Gb/s PDM-OFDM receiver 50. The optical link includes and number of Erbium doped fiber amplifiers (EDFA) 42 for amplifying the signal during its transport over a number of fiber spans 44. The optical link suffers from fiber nonlinearity, CD and PMD.

At the receiver 50, digital coherent detection with polarization diversity is used to sample the fields of two orthogonal components of the received optical signal at the receiver front end 52. Thus, the receiver front end includes Polarization Diversity Optical Hybrid 54 and analog-to-digital converters (ADC) 56. The ADC operates at a predetermined sampling rate, which can be the same as that of the DAC.

Symbol synchronization is then performed, and training symbols are extracted for channel estimation that obtains the effects PMD and CD on each OFDM subcarrier at the receiver digital signal processor (DSP) 58. Thus, DSP includes modules for symbol synchronization 60, prefix removal 62, parallel-to-serial conversion 64, Fast Fourier Transform (FFT) 66, pilot-assisted common phase error compensation (PA-CPEC) 68, symbol mapping 70, and serial-to-parallel conversion 72.

The DSP also includes modules for intra-symbol frequency-domain averaging based channel estimation (ISFA-based CE) 74 and channel compensation 76. The DSP may also include electronic dispersion compensation (EDC) module 78 which performs compensation before performing the channel estimation and compensation.

Descriptions on the channel estimation and compensation method follow below. The bandwidth of a single subcarrier is determined by the laser linewidth, which is usually so small that over the bandwidth, the frequency-domain transfer function of the transmission channel can be regarded as flat or constant. The combined effect of PMD and CD on a PDM-OFDM signal can be described as

$$[ \begin{matrix}{s}_{x}^{′} ( k ) \\ {s}_{y}^{′} ( k )\end{matrix} ] = [ \begin{matrix}a ( k ) & b ( k ) \\ c ( k ) & d ( k )\end{matrix} ] [ \begin{matrix}{s}_{x} ( k ) \\ {s}_{y} ( k )\end{matrix} ] , \qquad ( 1 )$$

where the 2×1 vectors on the left hand side and the right hand side of the equation are the received and the transmitted OFDM signal for the k-th subcarrier, and the 2×2 matrix is the channel matrix or Jones matrix representing the effect of CD and PMD. The channel matrix may also contain the effect of polarization-dependent loss (PDL). To easily estimate the PMD effect, a pair of time-multiplexed training symbols across the two polarization branches, t₁ and t₂, are inserted into the OFDM symbol sequence at the transmitter.

The training symbols can be written t₁ and t₂, as

$${t}_{1} = [ \begin{matrix}{t}_{x} \\ 0\end{matrix} ] , \\ {t}_{2} = [ \begin{matrix}0 \\ {t}_{y}\end{matrix} ] , \qquad ( 2 )$$

where tₓ and t_{y} are two known symbols, preferably with low peak-to-average-power-ratio (PAPR). Note that the pair of training symbols can be periodically inserted into the OFDM symbol sequence in order to capture dynamic channel behaviors. However, periodically does not connote any fixed time duration between insertion of the training symbols; the training symbols can be inserted from time to time. The same training symbol may be inserted each time or the training symbol can be changed after a predetermined number of insertions or after each insertion if proper notification is given.

Assuming that the two training symbols experience the same channel effect, the received training symbols can be written as

$$\begin{matrix}{t}_{1}^{′} ( k ) = [ \begin{matrix}{t}_{1 x}^{′} ( k ) \\ {t}_{1 y}^{′} ( k )\end{matrix} ] = [ \begin{matrix}a ( k ) {t}_{x} ( k ) \\ c ( k ) {t}_{x} ( k )\end{matrix} ] , & ( 3 ) \\ {t}_{2}^{′} ( k ) = [ \begin{matrix}{t}_{2 x}^{′} ( k ) \\ {t}_{2 y}^{′} ( k )\end{matrix} ] = [ \begin{matrix}b ( k ) {t}_{y} ( k ) \\ d ( k ) {t}_{y} ( k )\end{matrix} ] . & ( 4 )\end{matrix}$$

The channel matrix can then be obtained as

$$[ \begin{matrix}a ( k ) & b ( k ) \\ c ( k ) & d ( k )\end{matrix} ] = [ \begin{matrix}{t}_{1 x}^{′} ( k ) / {t}_{x} ( k ) & {t}_{2 x}^{′} ( k ) / {t}_{y} ( k ) \\ {t}_{1 y}^{′} ( k ) / {t}_{x} ( k ) & {t}_{2 y}^{′} ( k ) / {t}_{y} ( k )\end{matrix} ] . \qquad ( 5 )$$

The obtained channel matrices at different subcarrier frequencies are then inverted and applied to the subcarriers in the payload symbols for channel compensation that realizes polarization de-multiplexing, and compensation of PMD, CD, and/or PDL.

To increase the accuracy of channel estimation in the presence of noise and fiber nonlinearity, the intra-symbol frequency-domain averaging (ISFA) module determines an estimated channel matrix for each subcarrier using intra-symbol frequency domain averaging. To determine the estimated channel matrix for any one subcarrier, the averaging is over the estimated channel matrices for multiple adjacent subcarriers in the same training symbol pair. Typically, for subcarrier k, the averaging is performed over subcarrier k and its m left neighbors and/or m right neighbors, or totally up to (2m+1) adjacent subcarriers. The second estimated channel matrix for subcarrier k′ can then be expressed as follows

$$[ \begin{matrix}A ( {k}^{′} ) & B ( {k}^{′} ) \\ C ( {k}^{′} ) & D ( {k}^{′} )\end{matrix} ] = \frac{1}{min ( {k}_{max} , {k}^{′} + m ) - max ( {k}_{min} , {k}^{′} - m ) + 1} {\sum }_{k = {k}^{′} - m}^{{k}^{′} + m} [ \begin{matrix}a ( k ) & b ( k ) \\ c ( k ) & d ( k )\end{matrix} ] , \qquad ( 6 )$$

where kₘₐₓ and kₘᵢₙ are the maximum and minimum filled subcarrier indexes, respectively. In Eq. (6), the elements of the first estimated channel matrix for k outside [kₘᵢₙ, kₘₐₓ] are set to zero. However, the averaging may be performed over any number of left and/or right neighboring subcarriers and need not be symmetric.

The channel matrix estimated in this fashion is then used to perform channel compensation. The average phase of the pilots of each OFDM symbol is used for pilot-assisted common phase error compensation (PA-CPEC). The other signal processes needed to recover the original data are performed by other modules identified above and the transmitted signal is recovered for each subcarrier.

ISFA offers the benefits of reduced overhead and increased reaction speed. It is important to note that in the presence of large CD, a rough electronic dispersion compensation (EDC) may need to be performed prior to the ISFA. This is because in the presence of large CD, there is a large CD-induced phase variation across the subcarriers and the ISFA may cause inaccurate estimate of the channel matrices, particularly for edge subcarriers whose indexes are close to kₘₐₓ or kₘᵢₙ. As a design rule, it is desired that the CD-induced phase difference between the center subcarrier and the farthest subcarrier in the averaging process of the ISFA to be less than about 1 rad. After some derivations, it is found that the residual CD at the ISFA, denoted as D_{ISFA}, is desired to be limited such that it satisfies

$$\vert {D}_{ISFA} ( ps \text{/} nm ) \vert < \frac{{10}^{6}}{8 π \cdot Δ {f}_{OFDM} ( GHz ) \cdot Δ {f}_{ISFA} ( GHz )} , \qquad ( 7 )$$

where D_{ISFA} is in units of ps/nm, Δf_{OFDM}(GHz) is the optical bandwidth of the OFDM signal in GHz, and Δf_{ISFA}(GHz) is the optical frequency difference between the center subcarrier and the farthest subcarrier in the averaging process of the ISFA in GHz. For example, in our previous described 112-Gb/s PDM-OFDM system, we have Δf_{OFDM}(GHZ)=56*(1296/2048)=35.4, and Δf_{ISFA}(GHz)=56/2048*m=0.164 for m=6 in the ISFA, so according to Eq. (7), we need |D_{ISFA}|<˜6850 ps/nm. This can be achieved by applying optical dispersion compensation in the fiber link, or by performing a rough EDC prior to the ISFA. Note also that in the presence of large PMD, Δf_{ISFA} needs to be limited in order for the ISFA to be accurate. As a rough design rule, it is desired to satisfy the following condition

$$Δ {f}_{ISFA} ( GHz ) < \frac{{10}^{2}}{\overline{DGD} ( ps )} , \qquad ( 8 )$$

where D̅G̅D̅(ps) is the mean PMD in ps. For example, when D̅G̅D̅(ps)=100 ps, it is desired to have Δf_{OFDM}<1 GHz.

In addition, to save computational efforts, the channel estimation method described may update the channel information at a speed that is much slower than the real-time data speed, but much faster than the speed of channel physical changes, which is usually in the order kHz.

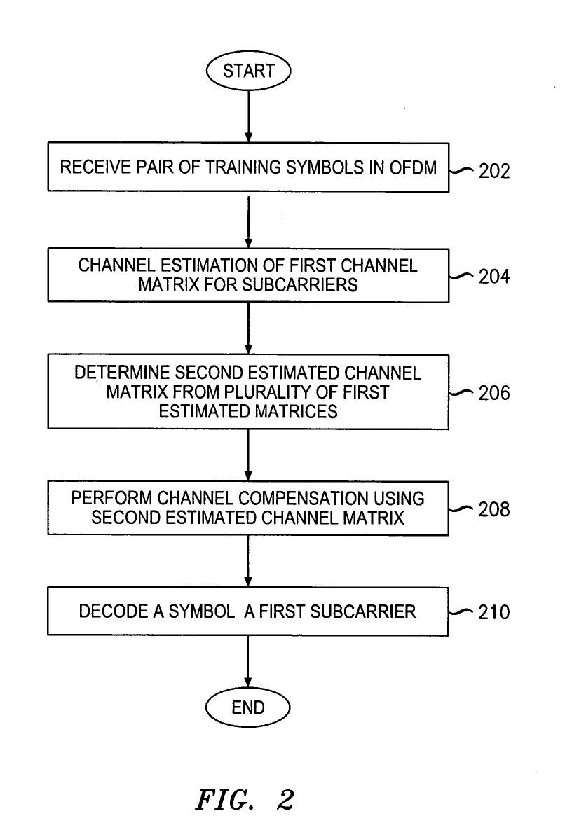

FIG. 2 is a flow chart illustrating an exemplary method in an orthogonal frequency-division multiplexed (OFDM) receiver for processing a signal according to an embodiment of intra-symbol frequency-domain averaging (ISFA) based channel estimation. Referring now to FIG. 2, a pair of training symbols in an optical orthogonal frequency-division multiplexed (OFDM) signal are received (Step 202). The pair of training symbols can be received periodically in the OFDM signal. The pair of training symbols may or may not be the same pair of training symbols for each reception of training symbols. If training symbols are changed, the receiver must be appropriately notified.

The training symbols may also be time-multiplexed training symbols and/or alternating in polarization. The OFDM signal is polarization-division multiplexed (PDM) in an embodiment of the invention.

At Step 204, channel estimation is performing to obtain a first estimated channel matrix for each of a plurality of subcarriers of the OFDM signal (Step 204). Estimation of the channel includes determining a functional relationship between the received pair of training symbols and a transmitted pair of training symbols on a per-subcarrier basis. Channel estimation relates the received pair of training symbols to an originally transmitted pair of training symbols. In the preferred embodiment, channel estimation is accomplished on per-subcarrier basis. Such channel estimation may occur periodically, each time a pair of training symbols is received in order to update the estimated channel matrices, following which the process flow may go back to Step 202.

At Step 206, the first estimated channel matrix of a first subcarrier is averaged with the first estimated channel matrix of at least a second subcarrier to obtain a second estimated channel matrix for the first subcarrier (Step 206). The second estimated channel matrix may be an average or a weighted average of channel matrices estimated in the first instance for some number different subcarriers. The different subcarriers used for calculating the averaged channel matrix can include the subcarrier being estimated in addition to a predetermined number of right neighboring subcarriers and/or left neighboring subcarriers. The first and/or second estimated channel matrices may be 2×2 matrix with complex numbers as elements.

For example, for each subcarrier, its 2×2 channel matrix can be the average of the directly estimated channel matrices of itself and its 12 nearest neighbors, i.e., 6 left neighbors and 6 right neighbors. As the number of subcarrier averaged to determine the second estimated channel is increased, channel estimation penalties with respect to the ideal channel estimation case are significantly reduced where ideal channel estimation refers to the case where channel matrices are obtained in the absence of optical noise. Such reductions in channel estimation penalties illustrate the effectiveness of the ISFA based channel estimation. In addition, this improved channel compensation performance is obtainable with low overhead and high reaction speed.

The method may include performing channel compensation based on the second estimated channel matrix for the first subcarrier of the OFDM signal (Step 208). For example, the second estimated channel matrix can be inverted and the inverted matrix multiplied with the received subcarrier vector for the first subcarrier of the OFDM signal to perform channel compensation.

The method may further include decoding a symbol for the first subcarrier based on the second estimated channel matrix. (Step 210). A second estimated channel matrix may also be determined for each subcarrier and used for compensation/decoding the OFDM signal of each subcarrier.

Optical dispersion compensation or electronic dispersion compensation (EDC) of the received training symbols and/or the received OFDM signal may also be performed in combination of the ISFA. EDC may be based on a guess of the dispersion experienced by the OFDM signal. In instances when EDC is performed, it is preferably performed to satisfy the condition of Eq. (7) before performing the ISFA.

All of the functions described above are readily carried out by special or general purpose digital information processing devices acting under appropriate instructions embodied, e.g., in software, firmware, or hardware programming.

What is claimed is:

1. A method of optical communication comprising:
receiving a pair of training symbols in an optical orthogonal frequency-division multiplexed (OFDM) signal;
performing channel estimation to obtain a first estimated channel matrix for each of a plurality of subcarriers of the OFDM signal; and
averaging the first estimated channel matrix of a first subcarrier with the first estimated channel matrix of at least a second subcarrier to obtain a second estimated channel matrix for the first subcarrier.

2. The method of optical communication in claim 1 further comprising
decoding a symbol for the first subcarrier based on the second estimated channel matrix.

3. The method of optical communication in claim 1 further comprising
performing channel compensation on the OFDM signal based on the second estimated channel matrix for the first subcarrier of the OFDM signal.

4. The method of optical communication in claim 3 wherein performing channel compensation comprises
inverting the second estimated channel matrix; and
multiplying the inverted matrix with the received subcarrier vector for the first subcarrier of the OFDM signal

5. The method of optical communication in claim 1 wherein a second estimated channel matrix is determined for each of the plurality of subcarriers.

6. The method of optical communication in claim 1 further comprising
averaging on a per subcarrier basis the first estimated channel matrix of each remaining subcarrier of the plurality of subcarriers with the first estimated channel matrix of at least one other subcarrier to obtain a second estimated channel matrix for each remaining subcarrier of the plurality of subcarriers; and
performing channel compensation on a per subcarrier basis based on the second estimated channel matrix for the plurality of subcarriers of the OFDM signal.

7. The method of optical communication in claim 1 wherein a pair of training symbols are received periodically in the OFDM signal.

8. The method of optical communication in claim 1 wherein a same pair of training symbols are received periodically in the OFDM signal.

9. The method of optical communication in claim 1 wherein the training symbols are time-multiplexed training symbols.

10. The method of optical communication in claim 1 wherein the OFDM signal is polarization-division multiplexed (PDM).

11. The method of optical communication in claim 1 wherein the training symbols are alternating in polarization.

12. The method of optical communication in claim 1 wherein performing channel estimation comprises:
determining a functional relationship between the received pair of training symbols and a transmitted pair of training symbols on a per-subcarrier basis.

13. The method of optical communication in claim 1 wherein the first estimated channel matrix is a 2×2 matrix with complex numbers as elements.

14. The method of optical communication in claim 1 wherein the second estimated channel matrix for the first subcarrier is an average of at least two first estimated channel matrices for at least two different subcarriers.

15. The method of optical communication in claim 14 wherein the second estimated channel matrix for the first subcarrier is an average of the first estimated channel matrix for the first subcarrier and the first estimated channel matrix of at least one right neighboring subcarrier or at least one left neighboring subcarrier.

16. The method of optical communication in claim 14 wherein the second estimated channel matrix for the first subcarrier is an average the first estimated channel matrix for the first subcarrier and the first estimated channel matrix of at least right neighboring subcarrier and at least one left neighboring subcarrier.

17. The method of optical communication in claim 1 further comprising
performing optical dispersion compensation or electronic dispersion compensation (EDC) on the received pair of training symbols and/or the received OFDM signal before performing the channel estimation.

18. The method of optical communication in claim 17 wherein the optical dispersion compensation or electronic dispersion compensation (EDC) is performed such that the following condition is satisfied
$$\vert {D}_{ISFA} ( ps \text{/} nm ) \vert < \frac{{10}^{5}}{8 π \cdot Δ {f}_{OFDM} ( GHz ) \cdot Δ {f}_{ISFA} ( GHz )} ,$$
where D_{ISFA} is the residual dispersion at the ISFA in units of ps/nm, Δf_{OFDM}(GHz) is the optical bandwidth of the OFDM signal in GHz, and Δf_{ISFA}(GHZ) is the optical frequency difference between the center subcarrier and the farthest subcarrier in the averaging process of the ISFA in GHz.

19. An optical communication system comprising:
orthogonal frequency-division multiplexed (OFDM) receiver, the receiver including
a receiver front-end for receiving a pair of training symbols in an optical OFDM signal; and
a channel estimation module for performing channel estimation to obtain a first estimated channel matrix for each of a plurality of subcarriers of the OFDM signal, and for averaging the first estimated channel matrix of a first subcarrier with the first estimated channel matrix of at least a second subcarrier to obtain a second estimated channel matrix for the first subcarrier.

20. The optical communication system of claim 19 further comprising:
an orthogonal frequency-division multiplexed (OFDM) transmitter, the transmitter including a training symbol insertion module for inserting a pair of training symbols into the OFDM symbol sequence.
